(19) United States
(12) Patent Application Publication
(10) Pub. No.: US 2016/0140191 A1
(43) Pub. Date: May 19, 2016

(54) METHOD AND APPARATUS FOR THE STORAGE AND RETRIEVAL OF TIME STAMPED BLOCKS OF DATA

(71) Applicant: Datos IO Inc., San Jose, CA (US)

(72) Inventors: Maohua Lu, Fremont, CA (US); Pin Zhou, San Jose, CA (US); Neville Carvalho, Saratoga, CA (US); Ajaykrishna Raghavan, Santa Clara, CA (US); Tarun Thakur, Fremont, CA (US); Prasenjit Sarkar, Los Gatos, CA (US)

(21) Appl. No.: 14/946,476

(22) Filed: Nov. 19, 2015

Related U.S. Application Data
(60) Provisional application No. 62/081,932, filed on Nov. 19, 2014.

(51) Int. Cl. G06F 17/30

(52) U.S. Cl. CPC G06F 17/30554; G06F 17/30528; G06F 17/30321

(57) ABSTRACT

Embodiments disclosed herein provide systems, methods, and computer readable storage media for time-based storage and retrieval of data items. In a particular embodiment, a method provides receiving a point-in-time data request. Using metadata associated with data items stored in a secondary data repository, the method provides determining a mapping between the point-in-time data request and one or more of the data items. The method further includes providing the one or more data items in response to the point-in-time data request.

### RELATED APPLICATIONS

This application is related to and claims priority to U.S. Provisional Patent Application 62/081,932, titled “METHOD AND APPARATUS FOR THE STORAGE AND RETRIEVAL OF TIME STAMPED BLOCKS OF DATA,” filed Nov. 19, 2014, and which is hereby incorporated by reference in its entirety.

### TECHNICAL BACKGROUND

A variety of computing technology exists that time-stamps data within a data storage system. For example, most operating systems record the date and time that each file was most recently saved. Some operating systems also record the creation date and time for each file.

Large data-intensive systems may produce large amounts of data during their normal operation. Some current implementations allow a user to choose a past point-in-time and restore the system data to that chosen point-in-time to allow a user to analyze the system at various previous points in time.

### OVERVIEW

Embodiments disclosed herein provide systems, methods, and computer readable storage media for time-based storage and retrieval of data items. In a particular embodiment, a method provides receiving a point-in-time data request. Using metadata associated with data items stored in a secondary data repository, the method provides determining a mapping between the point-in-time data request and one or more of the data items. The method further includes providing the one or more data items in response to the point-in-time data request.

In some embodiments, the method provides receiving a request to perform an operation on the one or more data items, performing the operation, and providing results of the operation.

In some embodiments, the operation comprises a search and the request to perform the search is received from a user.

In some embodiments, the operation comprises an application process.

In some embodiments, the request to perform an operation includes the point-in-time data request.

In some embodiments, the method provides identifying the data items in a primary data repository for storage in the secondary data repository, generating the metadata indicating time information for the data items, and storing the data items and the metadata in the secondary data repository.

In some embodiments, the method provides the time information includes a time when each of the data items was obtained from the primary data repository.

In some embodiments, the method provides that determining a mapping between the point-in-time data request and one or more of the data items comprises using the time information to identify the one or more data items that satisfy the point-in-time data request.

In another embodiment, a data processing system is provided, which includes one or more computer readable storage media, a processing system operatively coupled with the one or more computer readable storage media, and program instructions stored on the one or more computer readable storage media. The program instructions, when read and executed by the processing system, direct the processing system to receive a point-in-time data request. The program instructions further direct the processing to, using metadata associated with data items stored in a secondary data repository, determine a mapping between the point-in-time data request and one or more of the data items. The program instructions further direct the processing system to provide the one or more data items in response to the point-in-time data request.

This overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

FIG. 1A illustrates a flow chart of a method of storing and retrieving point-in-time blocks or pieces of data.

FIG. 1B illustrates a flow chart of another method of storing and retrieving point-in-time blocks or pieces of data.

FIG. 2 illustrates a block diagram of a computer system configured to operate as a data processing system.

FIG. 3 illustrates a computing environment for time-based storage and retrieval of data items.

FIG. 4 illustrates a method of operating the computing environment for time-based storage and retrieval of data items.

FIG. 5 illustrates a method of operating the computing environment for time-based storage and retrieval of data items.

FIG. 6 illustrates a method of operating the computing environment for time-based storage and retrieval of data items.

FIG. 7 illustrates an operational scenario of the computing environment for time-based storage and retrieval of data items.

FIG. 8 illustrates a block diagram of a computer system configured to operate as a data processing system.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by claims and their equivalents.

In a secondary data protection repository build according to the present invention, a user can run queries or analytic works directly on any point-in-time data as well as its associated metadata, without first restoring the specific point-in-time data as previous solutions require.

An exposed query interface, or other application interfaces such as file system interfaces, provides the time dimension of the data. The low-level system implementing the present invention quickly assembles fragmented data pieces together to provide the point-in-time data to the user. This allows the user to leverage the system to quickly determine the value of any of the point-in-time data, and thus make an informed decision on whether or not to restore the data. Using this system and method the user may save the significant amount of time required to do an unnecessary restore.

The solution described herein exposes various interfaces to the user so that the user may directly processes point-in-time data, as well as any associated metadata in the secondary repository without having to restore all of the data. The present invention quickly determines a mapping between the user requested point-in-time data and the stored fragmented data pieces, and then provides interfaces to present the requested point-in-time data to the user, allowing the user to directly run applications on the point-in-time data as well as any associated metadata in the secondary repository.

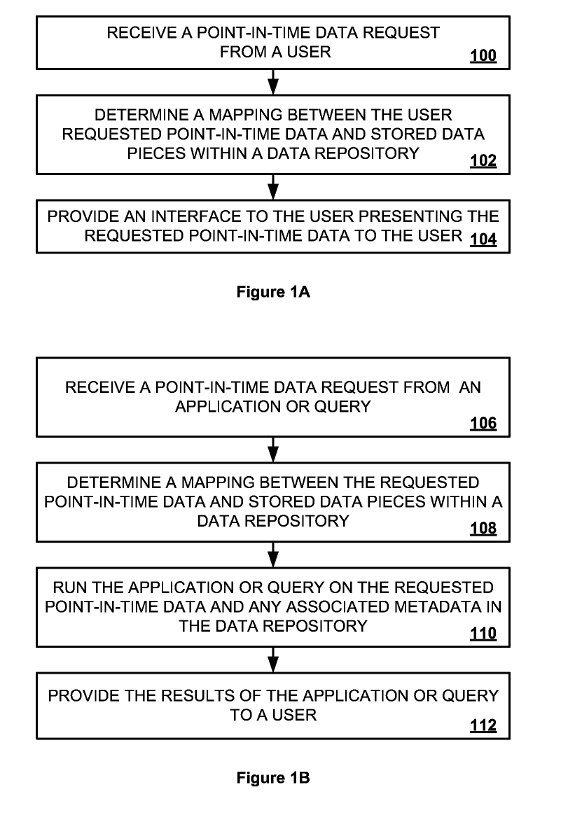

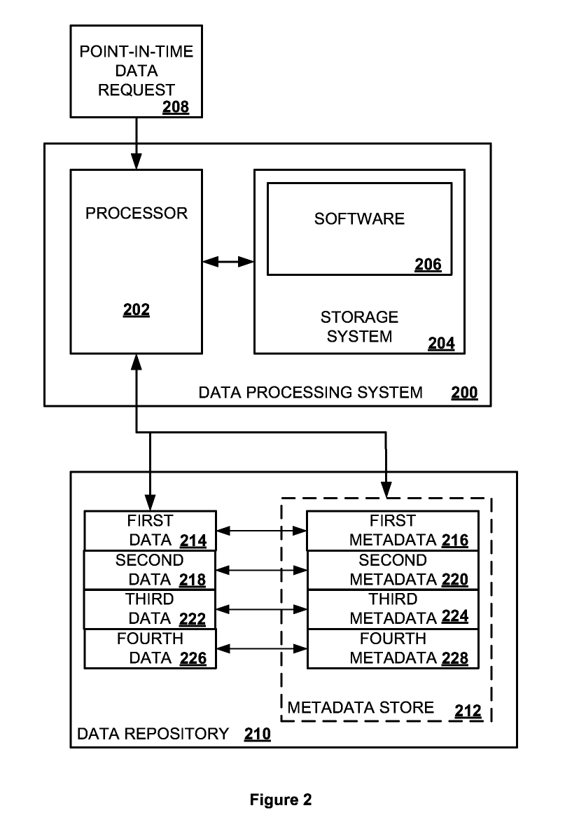

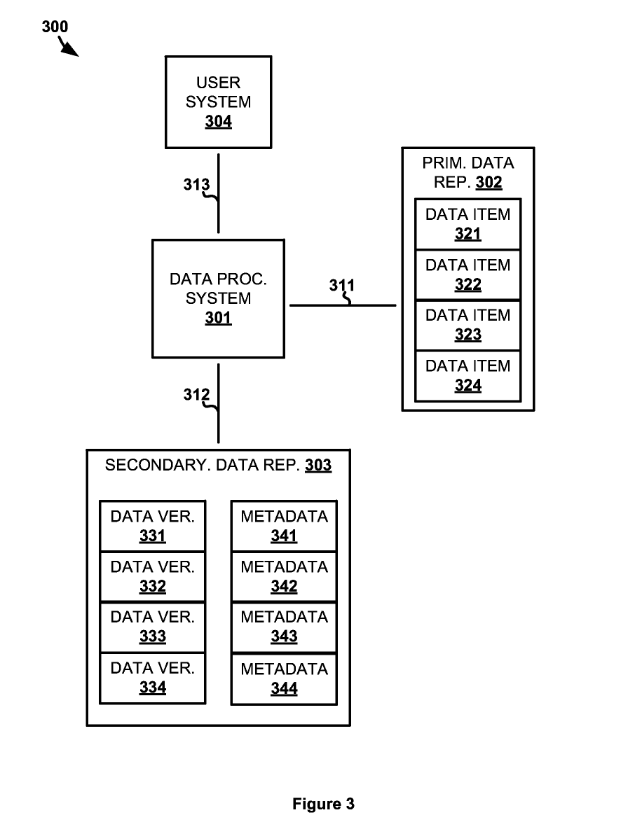

FIG. 1A illustrates a flow chart of a method of storing and retrieving time-in-point blocks or pieces of data. In this example embodiment, various blocks of data are organized, stored, and retrieved by data processing systems such as those illustrated in FIGS. 2 and 3 and described later. Various operations of this method may be performed by one or more data processing systems, and there is no need to tie any operation to any specific data processing system as general purpose computers may be configured to operate as a capable of performing the operations of the method described herein.

Data processing system 200 receives a point-in-time data request 208 from a user, (operation 100). Data processing system 200 then determines a mapping between the user requested point-in-time data and stored data pieces with data repository 210, (operation 102). Data processing system 200 provides an interface to the user presenting the requested point-in-time data to the user, (operation 104).

FIG. 1B illustrates a flow chart of another method of storing and retrieving time-in-point blocks or pieces of data. In this example embodiment, various blocks of data are organized, stored, and retrieved by data processing systems such as those illustrated in FIGS. 2 and 3 and described later. Various operations of this method may be performed by one or more data processing systems, and there is no need to tie any operation to any specific data processing system as general purpose computers may be configured to operate as a capable of performing the operations of the method described herein.

In this further example, data processing system 200 receives a point-in-time data request from an application or a query, (operation 106). Data processing system 200 then determines a mapping between the requested point-in-time data and stored data pieces with data repository 210, (operation 108). Data processing system 200 runs the application or query on the requested point-in-time data and any associated metadata 212 in data repository 210, (operation 110). Data processing system 200 then provides the results of the application or query to a user, (operation 112).

Referring now FIG. 2, data processing system 200 and the associated discussion are intended to provide a brief, general description of a suitable computing environment in which the processes illustrated in FIGS. 1A and 1B may be implemented. Many other configurations of computing devices and software computing systems may be employed to implement a system for the efficient storage, organization, and indexing of data blocks corresponding to particular creation times.

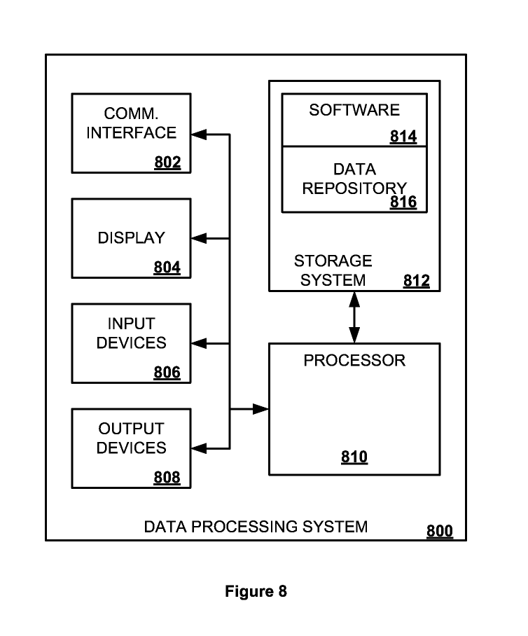

Data processing system 200 may be any type of computing system capable of processing graphical elements, such as a server computer, client computer, internet appliance, or any combination or variation thereof. FIG. 8, discussed in more detail later, provides a more detailed illustration of an example data processing system. Indeed, data processing system 200 may be implemented as a single computing system, but may also be implemented in a distributed manner across multiple computing systems. For example, data processing system 200 may be representative of a server system (not shown) with which the computer systems (not shown) running software 201 may communicate to enable data processing features. However, data processing system 200 may also be representative of the computer systems that run software 206. Indeed, data processing system 200 is provided as an example of a general purpose computing system that, when implementing the methods illustrated in FIGS. 1A and 1B, becomes a specialized system capable of operating as a data processing system.

Data processing system 200 includes processor 202, storage system 204, and software 206. Processor 202 is communicatively coupled with storage system 204. Storage system 204 stores data processing software 206 which, when executed by processor 202, directs data processing system 200 to operate as described for the methods illustrated in FIGS. 1A and 1B.

Referring still to FIG. 2, processor 202 may comprise a microprocessor and other circuitry that retrieves and executes data processing software 206 from storage system 204. Processor 202 may be implemented within a single processing device but may also be distributed across multiple processing devices or sub-systems that cooperate in executing program instructions. Examples of processor 202 include general purpose central processing units, application specific processors, and graphics processors, as well as any other type of processing device.

Storage system 204 may comprise any storage media readable by processor 202 and capable of storing data processing software 206. Storage system 204 may include volatile and nonvolatile, removable and non-removable media implemented in any method or technology for storage of information, such as computer readable instructions, data structures, program modules, or other data. Storage system 204 may be implemented as a single storage device but may also be implemented across multiple storage devices or sub-systems. Storage system 204 may comprise additional elements, such as a controller, capable of communicating with processor 202. Storage system 204 may also be implemented as private or public cloud storage.

Examples of storage media include random access memory, read only memory, magnetic disks, optical disks, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Data processing software 206 comprises computer program instructions, firmware, or some other form of machine-readable processing instructions having at least some portion of the methods illustrated in FIGS. 1A and 1B embodied therein. Data processing software 206 may be implemented as a single application but also as multiple applications. Data processing software 206 may be a stand-alone application but may also be implemented within other applications distributed on multiple devices, including but not limited to other human machine interface software and operating system software.

In general, data processing software 206 may, when loaded into processor 202 and executed, transform processor 202, and data processing system 200 overall, from a general-purpose computing system into a special-purpose computing system customized to act as a data processing system as described by the method illustrated in FIG. 1 and its associated discussion.

Encoding data processing software 206 may also transform the physical structure of storage system 204. The specific transformation of the physical structure may depend on various factors in different implementations of this description. Examples of such factors may include, but are not limited to: the technology used to implement the storage media of storage system 204, whether the computer-storage media are characterized as primary or secondary storage, and the like.

For example, if the computer-storage media are implemented as semiconductor-based memory, data processing software 206 may transform the physical state of the semiconductor memory when the software is encoded therein. For example, data processing software 206 may transform the state of transistors, capacitors, or other discrete circuit elements constituting the semiconductor memory.

A similar transformation may occur with respect to magnetic or optical media. Other transformations of physical media are possible without departing from the scope of the present description, with the foregoing examples provided only to facilitate this discussion.

Referring again to FIGS. 1A, 1B, and 2, through the operation of data processing system 200 employing data processing software 206, transformations are performed on first data 214, second data 218, third data 222, and fourth data 226 within data repository 210, and optionally on first metadata 216, second metadata 220, third metadata 224, and fourth metadata 228 within metadata store 212. As an example, point-in-time data request 208 could be received by processor 202 and used to determine a mapping between the user requested point-in-time data and various blocks or pieces of data within data repository 210. In some embodiments, metadata store 212 may be stored within data repository 210 and also mapped by processor 202.

Processor 202 then provides an interface to the user presenting the requested point-in-time data from data repository 210 to the user. This allows the user to interface with the requested point-in-time data without having to restore all of the requested point-in-time data.

When the user sends an application request to data processing system 200, processor 202 retrieves the application from data processing software 206 and runs the application on the requested point-in-time data (and any metadata) retrieved from data repository 210. Finally, processor 202 provides the results of the application to the user.

Further details on an example data processing system 200 are illustrated in FIG. 8 and described below. Data processing system 200 may have additional devices, features, or functionality. Data processing system 200 may optionally have input devices such as a keyboard, a mouse, a voice input device, or a touch input device, and comparable input devices. Output devices such as a display, speakers, printer, and other types of output devices may also be included. Data processing system 200 may also contain communication connections and devices that allow data processing system 200 to communicate with other devices, such as over a wired or wireless network in a distributed computing and communication environment. These devices are well known in the art and need not be discussed at length here.

FIG. 3 illustrates computing environment 300 for time-based storage and retrieval of data items. Computing environment 300 includes data processing system 301, primary data repository 302, secondary data repository 303, and user system 304. Data processing system 301 and primary data repository 302 communicate over communication link 311. Data processing system 301 and secondary data repository 303 communicate over communication link 312. Data processing system 301 and user system 304 communicate over communication link 313.

Primary data repository 302 and secondary data repository 303 include storage media, such as one or more hard disc drive, flash memory, magnetic tape, data storage circuitry, or some other memory apparatus—including combinations thereof. Primary data repository 302 and secondary data repository 303 may also include other components such as processing circuitry, a router, server, data storage system, and power supply. Primary data repository 302 and secondary data repository 303 may reside in a single device or may be distributed across multiple devices. In some examples, data processing system 301 may be incorporated into one or both of primary data repository 302 and secondary data repository 303.

Communication links 111-113 could use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format—including combinations thereof. Communication links 111-113 could be direct links or may include intermediate networks, systems, or devices.

In operation, the point-in-time data, as data versions 331-334, from primary data repository 302 are typically stored in a virtual incremental manner for efficiency. The first version (point-in-time) is typically a full version where the entire range of data comes from a single file. The data stored in the repository for subsequent point-in-time are only incremental data or changes. When a point-in-time data is requested by a user, the system will provide the full data for the point-in-time based on the incremental data stored. The full data of any subsequent point-in-time is described as a function of all previous point-in-time (incremental or full) data stored as well as the incremental data of this point-in-time itself. More specifically, every range for the full data in this point-in-time is mapped as belonging to the incremental data of this point-in-time and/or some incremental or full data of previous point-in-time.

For example, the point-in-time full data at a time t5 might be 100 bytes long, where the first 30 bytes come from the incremental point-in-time data stored at t5 and the remaining 70 bytes come from the incremental point-in-time data stored at t3 starting at offset of 15.

So the requirement is to support interval queries on ranges within a point-in-time full data that is a function of multiple ranges over several prior point-in-time incremental data and the incremental data for this point-in-time. The information is needed to form the full data for the point-in-time is the numerical ranges (or interval ranges) within the stored data items. A range is specified by a value pair, 1 and h such that 1<=h, representing an interval [1, h]. For the previous example, the full data for t5 is formed by: {data_t5: [0, 30], data_t3: [15, 84]}

An array-based storage scheme and a brute-force search through the entire list of point-in-time incremental data is acceptable only if a single extraction is to be performed or if the number of incremental data items is small. Unfortunately, this technique becomes increasingly ineffective as the number of ranges approach the millions. Accordingly, data processing system 301 maintains a self-balancing Binary Search Tree (BST) like Red Black Tree, AVL Tree, etc to maintain set of intervals so that all operations can be done in O(Logn) time.

Every node of Interval Tree stores following information. a) i: An interval which is represented as a pair [low, high] and b) height: height of subtree rooted with this node. The low, high value (1, h) of an interval is used as key to maintain order in the BST. The insert and delete operations are same as insert and delete in self-balancing BST used.

Additionally, data processing system 301 supports node splits and merges. As new point-in-time data items are generated before older point-in-time data items are retired, nodes may need to split and merged. For example, if the block range 0-100 was obtained from the first point-in-time, and in the fifth point-in-time, there is a write to block range 20-50, then there are three ranges where ranges 0-19 and 51-100 are obtained from the first point-in-time data and ranges 20-50 is obtained from the fifth point-in-time data. Similarly, ranges can be merged.

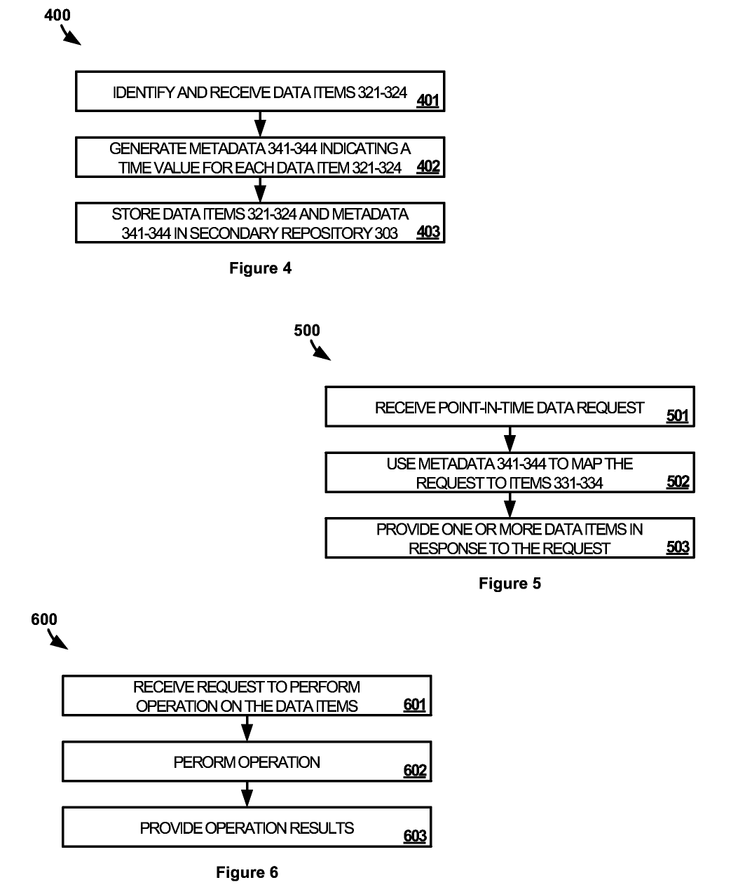

FIG. 4 illustrates method 400 of operating computing environment 300 for time-based storage and retrieval of data items. In particular, method 400 provides data processing system 301 identifying the data items in a primary data repository for storage in the secondary data repository (401). Data processing system 301 may use information received from primary data repository 302 to identify the data. For example, primary data repository 302 may transfer an indication of what data should be transferred to secondary data repository 303 or may transfer the data. Step 401 may occur periodically, as may be the case if data processing system 301 is configured to periodically create backup versions of primary data repository 302 in secondary data repository 303.

In this example, data items 321-324 are determined to be the data items that need to be stored in secondary data repository 303. While only four individual data items 321-324 are shown, it should be understood and any number of data items may be identified at step 401. Initially, data items 321-324 may include all data items present on primary data repository 302. However, after an initial copy of data items on primary data repository 302 to secondary data repository 303, it is typical to only backup changed data items on data processing system 301 while relying on previously stored unchanged data items for the sake of resource efficiency. Therefore, for the purposes of this example, data items 321-324 will be considered only the changed data items to be included in an incremental backup.

Method 400 further provides data processing system 301 generating metadata indicating time information for data items 321-324 (402). The metadata indicates time information for data items 321-324. In one example, the time information indicates a time when a version (i.e. incremental backup) including data items 321-324 was created and the metadata further associates data items 321-324 with that time. The time information could correspond to other times, such as when data items 321-324 were read from primary data repository 302 or some other time associated with creation of the version including data items 321-324.

Additionally, method 400 provides data processing system 301 storing data items 321-324 as data version 331 in secondary data repository 303 and the metadata as metadata 341 in secondary data repository 303 (403). Each item of metadata 341-344 therefore corresponds to a respective one data versions 331-334, with the higher numbered data version corresponding to older data versions. As such, each of metadata 341-344 indicates an association of data items in their corresponding data version 331-334 to each version's creation time. Metadata 341 may be stored as a separate item of information in secondary data repository 303 or may be incorporated into a comprehensive structure of meta data information, such as the BST described above. This structured metadata can then be used to identify data items that satisfy the point-in-time data request. For instance, the nature of incremental versions means that only data items that have been changed since a previous version are stored in subsequent versions. Thus, if any one of data versions 331-334 was restored to primary data repository 302, that version would include data items that were stored in a previous version but were not changed by the time the version for restoration was created. Accordingly, if the point-in-time data request indicates data items that were present in primary data repository 302 at the time data version 333 was generated, then the structured metadata indicates in which version of data versions 333-334 (or in even older un-shown data versions) the data items are actually stored in secondary data repository 303.

FIG. 5 illustrates method 500 of operating computing environment 300 for time-based storage and retrieval of data items. In particular, method 500 provides receiving a point-in-time data request (501). The point-in-time data request in this example is received from user system 304 over communication link 313. For instance, a user of user system 304 may provide user input instructing user system 304 that the user wants an operation to be performed on data that satisfies the point-in-time data request. User system 304 therefore transforms that user input into a message that includes the point-in-time data request for transfer to data processing system 301. The point-in-time data request may indicate a time range for requested data, may indicate a time of a specific version, a range of versions, or some other manner of indicating a time parameter.

Using metadata 341-344 stored in secondary data repository 303, method 500 provides data processing system 301 determining a mapping between the point-in-time data request and one or more of the data items stored in data versions 331-334 (502). Specifically, as noted in method 400 above, metadata 341-344 is structured in this example such that data processing system 301 can reference the structured metadata for time specified by the point-in-time data request. The structured metadata 341-344 indicates in which of incremental data versions 331-334 data items satisfying the specified time. For example, if the indicated time corresponds to the time of data version 332′s creation, then metadata 331-334 indicates in which of data versions 332-334 (or in older un-shown data versions) data items that are part of data version 332 are stored in secondary data repository 303. These identified data items are the one or more data items mapped to in step 502.

Method 400 then includes data processing system 301 providing the one or more data items in response to the point-in-time data request (503). Providing the one or more data items may comprise data processing system 301 reading the one or more data items from secondary data repository 303 and transferring them to user system 304, providing user system 304 with pointers to the one or more data items in secondary data repository 303, data processing system 301 using the one or more data items itself in response to instructions from user system 304, or any other means in which data items can be accessible from a data repository.

FIG. 6 illustrates method 600 of operating computing environment 300 for time-based storage and retrieval of data items. Method 600 provides that data processing system 301 receives a request to perform an operation on the one or more data items provided in step 503 of method 500 (601). The request to perform the operation may be received from user system 304 or from some other source. In one example, the request to perform the operation includes, implies, or otherwise indicates the point-in-time data request. For example, the request to perform the operation may itself specify a time for the data upon which data processing system 301 should operate. The operation may comprise a search of the data, an application having instructions for data processing system 301 to process the data (e.g. to create statistics from the data items, create new data from the data items, etc.), or some other operation that can be performed on data.

Data processing system 301 then performs the operation in response to the request (602) and provides the results of the operation (603). The results may be provided to user system 304, may be stored in secondary data repository 303, may be stored in primary data repository 302, stored in data processing system 301, displayed to a user of data processing system 301, may be stored or transferred to some other system, or handled in some other way of managing data. In one example, if the operation request is a search query from a user via user system 304, then data processing system 301 returns the results of searching the one or more data items (i.e. data items that satisfy the search query). User system 304 would present those results to its user upon receiving them from data processing system 301.

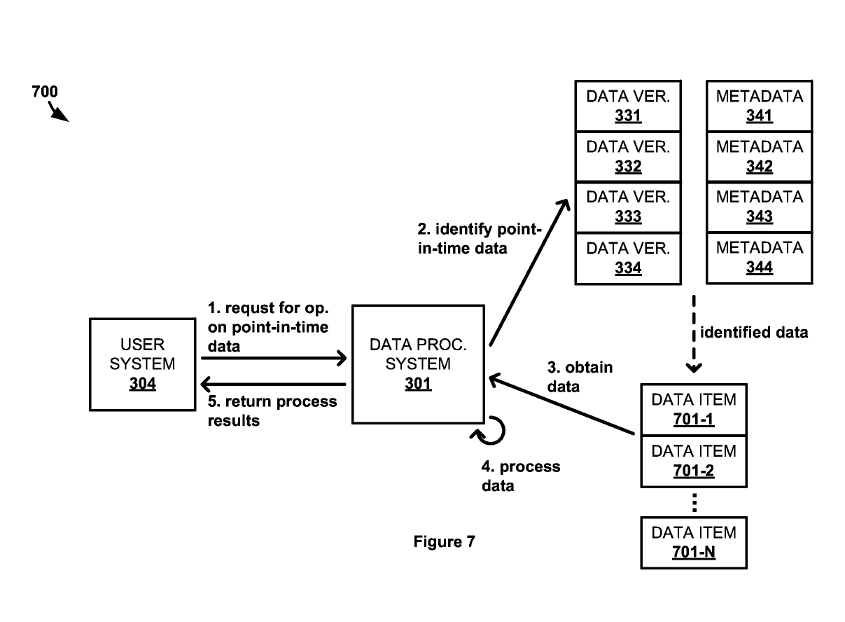

FIG. 7 illustrates operational scenario 700 of computing environment 300 for time-based storage and retrieval of data items. At step 1, a request to perform an operation on point in time data is transferred from user system 304 to data processing system 301. At step 2, data processing system 301 uses metadata 341-344 to identify the point-in-time data that will be operated on. In this example, the point-in-time indicated by the request corresponds to data version 331. Therefore, data processing system 301 identifies data items that are included in data version 331, which includes data items that were stored in previous incremental data versions 332-334 and not changed (i.e. modified or deleted) before data version 331 was created. In this case, only data items 701-1 through 701-N are identified from data versions 331-334.

At step 3, data processing system 301 obtains data items 701 and data items 701 are processed in a data process operation at step 4. The results of the data processing operation are then transferred to user system 304 at step 5. Advantageously, user system 304 scenario 700, and the other embodiments above, allow for data processing system 301 to access and operate on data items in particular data versions stored on secondary data repository 303 without first having to restore a version to primary data repository 302 or elsewhere.

FIG. 8 illustrates a block diagram of a computer system configured to operate as a data processing system 800. The methods illustrated in FIGS. 1A and 1B are implemented on one or more data processing systems 800, as shown in FIG. 8. Data processing system 800 includes communication interface 802, display 804, input devices 806, output devices 808, processor 810, and storage system 812. Processor 810 is linked to communication interface 802, display 804, input devices 806, output devices 808, and storage system 812. Storage system 812 includes a non-transitory memory device that stores operating software 814.

Communication interface 802 includes components that communicate over communication links, such as network cards, ports, RF transceivers, processing circuitry and software, or some other communication devices. Communication interface 802 may be configured to communicate over metallic, wireless, or optical links. Communication interface 802 may be configured to use TDM, IP, Ethernet, optical networking, wireless protocols, communication signaling, or some other communication format—including combinations thereof.

Display 802 may be any type of display capable of presenting information to a user. Displays may include touch screens in some embodiments. Input devices 806 include any device capable of capturing user inputs and transferring them to data processing system 800. Input devices 806 may include a keyboard, mouse, touch pad, or some other user input apparatus. Output devices 808 include any device capable of transferring outputs from data processing system 800 to a user. Output devices 808 may include printers, projectors, displays, or some other user output apparatus. Display 804, input devices 806, and output devices 808 may be external to data processing system 800 or omitted in some examples.

Processor 810 includes a microprocessor and other circuitry that retrieves and executes operating software 814 from storage system 812. Storage system 812 includes a disk drive, flash drive, data storage circuitry, or some other non-transitory memory apparatus. Operating software 814 includes computer programs, firmware, or some other form of machine-readable processing instructions. Operating software 814 may include an operating system, utilities, drivers, network interfaces, applications, or some other type of software. When executed by processing circuitry, operating software 814 directs processor 810 to operate data processing system 800 according to the methods illustrated in FIGS. 1A and 1B.

In this example, data processing system 800 executes a number of methods stored as software 814 within storage system 812. The results of these methods are displayed to a user via display 804, or output devices 808. Input devices 806 allow a user to send point-in-time data requests to data processing system 800.

For example, processor 810 receives point-in-time data requests either from communication interface 802 or input devices 806. Processor 810 then operates on the point-in-time data requests to provide point-in-time data from storage system 812 (within data depository 816), for display within an interface on display 804, or output through output devices 808. Processor 810 also operates on data stored in data depository 816, reading and writing blocks or other pieces of data, and metadata corresponding to the blocks or other pieces of data.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a data processing system for time-based storage and retrieval of data items, the method comprising:
receiving a point-in-time data request;
using metadata associated with data items stored in a secondary data repository, determining a mapping between the point-in-time data request and one or more of the data items; and
providing the one or more data items in response to the point-in-time data request.

2. The method of claim 1, further comprising:
receiving a request to perform an operation on the one or more data items;
performing the operation; and
providing results of the operation.

3. The method of claim 2, wherein the operation comprises a search and the request to perform the search is received from a user.

4. The method of claim 2, wherein the operation comprises an application process.

5. The method of claim 2, wherein the request to perform an operation includes the point-in-time data request.

6. The method of claim 1, further comprising:
identifying the data items in a primary data repository for storage in the secondary data repository;
generating the metadata indicating time information for the data items; and
storing the data items and the metadata in the secondary data repository.

7. The method of claim 6, wherein the time information includes a time when each of the data items was obtained from the primary data repository.

8. The method of claim 6, wherein determining a mapping between the point-in-time data request and one or more of the data items comprises:
using the time information to identify the one or more data items that satisfy the point-in-time data request.

9. A data processing system for time-based storage and retrieval of data items, the data processing system comprising:
one or more computer readable storage media;
a processing system operatively coupled with the one or more computer readable storage media; and
program instructions stored on the one or more computer readable storage media that, when read and executed by the processing system, direct the processing system to;
receive a point-in-time data request;
using metadata associated with data items stored in a secondary data repository, determine a mapping between the point-in-time data request and one or more of the data items; and
provide the one or more data items in response to the point-in-time data request.

10. The data processing system of claim 9, wherein the program instructions further direct the processing system to:
receive a request to perform an operation on the one or more data items;
perform the operation; and
provide results of the operation.

11. The data processing system of claim 10, wherein the operation comprises a search and the request to perform the search is received from a user.

12. The data processing system of claim 10, wherein the operation comprises an application process.

13. The data processing system of claim 10, wherein the request to perform an operation includes the point-in-time data request.

14. The data processing system of claim 9, wherein the program instructions further direct the processing system to:
identify the data items in a primary data repository for storage in the secondary data repository;
generate the metadata indicating time information for the data items; and
store the data items and the metadata in the secondary data repository.

15. The data processing system of claim 14, wherein the time information includes a time when each of the data items was obtained from the primary data repository.

16. The data processing system of claim 14, wherein the program instructions that direct the processing system to determine a mapping between the point-in-time data request and one or more of the data items comprises program instructions that direct the processing system to:
use the time information to identify the one or more data items that satisfy the point-in-time data request.
